(19) United States
(12) Patent Application Publication
(10) Pub. No.: US 2013/0145240 A1
(43) Pub. Date: Jun. 6, 2013

(54) Customizable System for Storytelling

(71) Applicants: Thomas G. Anderson, Albuquerque, NM (US); Bill Anderson, Albuquerque, NM (US); V. Gerald Grafe, Corrales, NM (US)

(72) Inventors: Thomas G. Anderson, Albuquerque, NM (US); Bill Anderson, Albuquerque, NM (US); V. Gerald Grafe, Corrales, NM (US)

(21) Appl. No.: 13/705,159

(22) Filed: Dec. 4, 2012

Related U.S. Application Data
(60) Provisional application No. 61/730,554, filed on Nov. 28, 2012.
(60) Provisional application No. 61/566,756, filed on Dec. 5, 2011.

(51) Int. Cl. G06F 3/0483

(52) U.S. Cl. CPC G06F 3/0483
USPC 715/201; 715/776

(57) ABSTRACT

A system for creating customizable books or other applications is described, along with techniques and methods for implementing customizable features in the books or applications.

### CROSS REFERENCE TO RELATED APPLICATIONS

This application claims priority to U.S. provisional application 61/730,554, filed 28 Nov. 2012; and to U.S. provisional application 61/566.756, filed 5 Dec. 2011; each of which is incorporated herein by reference.

### BACKGROUND OF THE INVENTION

The present invention is in the technical field of books or stories that are customized. It encompasses electronic books and stories, computer applications used to tell a story, or forms used to create a customized story which is then delivered in a physical form. Many stories and books for children and adults alike are now published electronically rather than as a physical book. They are distributed through e-readers like Amazon's Kindle, through tablet computers like Apple's iPad, or online for reading on a personal computer, laptop, or netbook. Electronic formats allow quick and easy purchases and distributions, often in a more compact and more convenient physical format than a book would provide. Given the fact that an electronic format also gives more functionality and flexibility on how stories and books are presented to a customer, electronic distribution of stories has also expanded into applications where there is a higher level of interaction than simply reading the story. Electronic stories can have music and sound effects, interactive elements that can be clicked on or touched to create an action, or customization to suit a user's preferences. For example, the font size of a book can be changed, the volume of sound effects can be adjusted, many items or interactive elements in a story might perform an action when touched or clicked on, and even the text of a story can be modified by a user before reading a book. There are a number of websites on the Internet that allow a parent to enter a child's name, for example, into an online form and order a physical or electronic copy of a story that then has the child's name inserted into the text of the story. As another example, Madlibs types of stories allow many words to be placed in a story categorized by concepts like action, verb, noun, etc., but those stories don't tell a longer story and are meant to be silly. Some stories allow a user to choose directions in the story from a preset number of already written story lines. Some electronic stories even allow customization of the main character. For example, a parent can choose settings such as skin color or hair color that create a character that resembles their child as the protagonist in the story. Despite all of the advancements achieved in adding to the level of interactivity in electronic stories, there are still a number of shortcomings to existing methods. Modifications to the actual text in a story are limited to simple substitutions and insertions, and the amount that a story can vary is limited in nature. Although there are many stories with interactive elements, customizable stories do not significantly differ in how they are told, who is in the story, or suitability to a wider range of readers and preferences.

### SUMMARY OF THE INVENTION

The present invention(s) provide a system, and aspects thereof, that facilitates delivery or presentation of a book in an electronic or physical format. Details of the story, how it is told, how it is displayed, the text of the story, who is in the story, the flow of the plot, how a user interacts with it, or any other preferences can be customized in order to make the story more entertaining, more interactive, or better suited to a reader's preferences. The present invention(s) also provide several methods and apparatuses that can facilitate implementation and presentation of electronic books.

### BRIEF DESCRIPTION OF THE DRAWINGS

FIG. 1 is a block diagram of the process for customizing pages in an example embodiment of the present invention;

FIG. 2 shows variations of an example page that has graphics on it, with different characters overlaid on a background image and text on the page telling a portion of a story.

FIG. 3 is a schematic representation of multiple apps implementing a distributed system according to some example embodiments of the present invention(s).

### DETAILED DESCRIPTION OF THE INVENTION

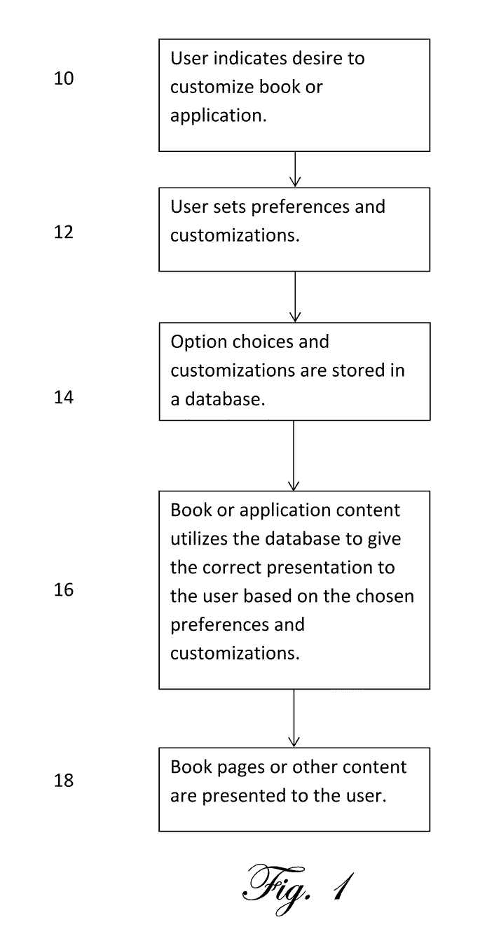

The present invention(s) provides a customizable story or book. A user can customize the book to his or her preference and the book can be delivered in either an electronic format or a physical format. An example embodiment of how pages are customized and presented to the user is shown in FIG. 1. In this example embodiment, a user would make a selection indicating that he or she wants to set preferences or customize a book or story 10. Setting preferences can be implemented directly in a book or other application, or it can be done online as part of a form or in setting up a user profile. A user can indicate that a user profile or online database is desired to be modified, which then later can modify a book's or game's customizable features. Similarly, other applications like games can be customized rather than just books. The user would then make selections or give inputs to customize the story 12. Based on selections that a user makes, a database would record the information 14 after the user has set preferences. A database can be as simple as simply recording values into variables or it can be a complicated multidimensional database. Before pages are then shown to a user, the pages would be appropriately modified using the database in order to give the appropriate presentation to the user based on the chosen customizations 16. The book's customized pages are then presented to a user 18. Details and variations of this example embodiment are described below.

Books presented to a user can be classic books, new books, or parodies on classics. The books can be modified to be related to a user such as Will and the Beanstalk, instead of Jack and the Beanstalk, or The Rabbit Who Stole Christmas instead of The Grinch Who Stole Christmas, if the user likes rabbits. The graphics in a book can make it look like a physical pop-up book.

A story presented to a user utilizing the present invention(s) includes a method for the user to customize the story. A common method of allowing a user to customize a story would be an options page within an electronic story application or on a page or on a website. Alternatively, options can be presented to the user as the story is told. Alternatively options can be inferred or taken directly from other inputs from the user such as an online database or an online profile. The customization page or options page allows a user to customize any number of aspects of the story, and can be separated into multiple pages, can be scrolled through, can be implemented as an online profile, or can be implemented using common user interface techniques. A customization page can be broken into different categories, such as customizations to the story as a whole, customizations for characters in the story, choices of characters or objects in the story, choices of text to appear in the story, or preferences on how the story is read, or any other aspects that a user would like to describe a preference for. Customizable components can be presented to a user through standard computer interface techniques like buttons and sliders, text input fields, voice recognition, pull down menus, or other user interface techniques. User interface components can help guide the user's choices. A combo box component can be used where there are a limited set of choices where a text field can be used where any combination of letters and words is possible. A text field might limit the number of characters, or size of a word, to assure that text can fit on a page later in the story. A text box might automatically capitalize a word that is a proper noun, or remove capital letters from words that should not be capitalized. The options page can include guidance for an entry. Below a ‘favorite food’ text input box, the options page might show text such as “let's eat some ______”, so that the user does not enter “hot dog” instead of “hot dogs”. Alternatively, the application might automatically adjust inputs to fit the text. The text “hot dog” might automatically be adjusted in one sentence in the story to read “I like hot dogs”, but left as ‘hot dog’ in another sentence such as “I would like a hot dog”. The text can be adjusted to differentiate between “pie” or “a slice of pie”, or “cake” instead of “a piece of cake”. A database of the most common or likely answers and how they need to be modified for specific blocks of text can be included in the book application, or an artificial intelligence system can be included, so that a user has more flexibility in inputting preferences and customizing the story. The system can adjust for grammatical mistakes. It can adjust related words and modifiers such as “he” or “she. For example, the system can keep track of the most common foods kids like to eat, and maintain the plural and singular forms of those foods so that the text is appropriately entered into the text of the story as it is presented to the user. The ways that a database modifies text can be adjusted by a user as well, or can be adjusted by user defined characteristics such as user preferences, a user profile, or an online database. For example, a higher reading level would imply that the system could utilize more sophisticated words or forms of words.

A person can customize a book before sending the book to another person as a gift. For example a grandparent can go online and customize a book for a grandchild, as a gift. Then the book can be delivered with those default customizations.

In the options page, details and book elements that can be modified include concepts like the details or images of the main character or protagonist in a story; details or images of the antagonist in a story; details or images of companions, friends, or other characters or objects in a story; details, images, and preferences for characters or items in the story or for the customer; the text of a story; pages in the story; the flow of a story; the background images of a story; the flow and direction of the plot in the story; the length of the story; available plot turns, twists, or paths; or interactive elements of the story. For the purposes of this Specification, stories, books, or other related words are interchangeable terms and include the telling of a story of any length and of any format or presentation. Example embodiments include picture books with text on each page along with graphical images, books comprised solely of text or largely text with a few images, or highly detailed and interactive applications with many multimedia elements and many interactive elements. Many of the concepts for stories also can be applied to games and video games. References to users or readers includes, without limitation, one person customizing the story for another person's use. Characters used in examples (such as a bear or dinosaur) can be any other type of character, and any example names used can be any other name. When an example describes that a character, object, or any other book element can be chosen, utilized, modified or in other ways interacted with, it can refer to a single instance or it can refer to a concept that can be implemented through related sets of data. For example, if an example describes that a character can be chosen, that can imply that when that character is chosen, multiple images and words throughout the book are modified, inserted, or utilized to implement that choice of character.

The story can include a feature where it is easy for a user to indicate that they want to go to the options page at any point in the story, such as a button that takes the user to the options page, and the ability to return to where the user was at before going to the options page.

Customizations can include book elements that are concepts and details such as the main character's name, the main character's sex or age, the main character's or other characters' preferences or description (such as age, skin color, eye color, race, favorite food, guardians, phone number, address or location, favorite activity, favorite sports team, favorite player, actress, or singer, favorite movie or TV show, etc.), character personalities, types of other characters or objects and their details, or details on a book dedication. Customizations also include broader concepts as well, described in more detail later in the Specification. Customizations and aspects of a book listed throughout the Specification are included in book elements or game elements, and whenever a book element is described to be modifiable, other book elements not specifically described in a given example can also be modified.

Although the simple customization of some details like these is common in current customizable books, current implementations only do a small subset and simple implementation of these types of concepts, such as the substitution of text name as the protagonist's name. Embodiments of the present invention(s) can provide a higher level of customization across a variety of types of options to make a user feel more connected with the story and to make the story more enjoyable. The combination of more options that are customizable and broader categories of customization presents new challenges in implementation in addition to more ability to draw a user into a story and make a user feel connected to the story.

For example, having a large number of customizable fields that are then entered into the text of the story can create wide variations of the size of a text box on a page. This creates a problem when presenting the text to the user if the text needs to be on a specific page, such as a children's book with images and text boxes, as an adjustable length text box with too much text might get clipped on the page. Another similar problem occurs when a story is displayed on varying screen sizes such as on a tablet versus a mobile phone where smaller screens create less room for a text box. This is a common issue even for non-customizable books, but the developer usually figures out placements of text boxes before delivering the story to the user. When there are large amounts of customizable text, it is a more difficult problem. One solution to this issue is to detect when a text box is too large to fit on a page, and dynamically break it into multiple text boxes, where the user can then transition through the multiple text boxes on a single page. The process needs to be determined programmatically since the actual final text presented to the user is not known until the user has set his or her preferences and customizations. When using this separate text boxes approach, a button can indicate when more text boxes are available on a given page, and can be labeled as something like ‘More’ or something similar. When the ‘More’ button is pushed the box in the text box can change so to the next set of text for that page appears. When the ‘More’ button is available, regular page turning can be disabled to make sure that the user sees all of the text without moving on accident, and the normal page turning methods, like a finger swipe, can move to the next text box instead of the next page. Another solution is to define a maximum sized text box for a given page and then dynamically add a scroll bar to the text box window if the customized text is larger than what will fit in the text box, allowing the user to scroll through additional text. The ways that the text is broken up or set to scroll can be determined at any time after the preferences are set, such as when the page is activated or just after the text is customized, when leaving an options page.

A common feature in electronic books is to have a mode where the book automatically reads to a user. This can be useful for young readers or other situations where it is more convenient to listen rather than read. With a customizable book, however, pre-recorded versions of the book are not possible since the final text of the book is not known until the user sets all of their preferences. One embodiment of the present invention(s) addresses this problem by allowing a user to record their own voice while reading a final version of the text. For example, a parent can record a final version of a story intended for a child, and then the child can later listen to the story alone if the parent is not available. After recording a version of the story, the words can be presented to a user on the screen as the recording is played. Then the user can touch or click the words as the recording plays them to allow the synchronization of which words are being read at any given point during the recording. Alternatively, voice recognition software and processing of breaks or changes in the audio stream can be analyzed to automatically recognize which words are spoken during a recording to match up the text and the recording. When text is matched up to the audio, words can be graphically changed, highlighted or otherwise emphasized, as each word is spoken while the audio plays to help a user learn how to read. The audio for characters' quotes can be modified so that a character's voice sounds deeper, higher, faster, slower, or modified in any other way to make the reading sound funny, more realistic, or more fun. The choice of a character or other options can adjust how audio is modified for quoted text. Another preference that can be available when a story is read to a user is the speed at which the story is read. Another preference that can be available is to show text that is read, or have the text only come from the audio. Another preference that can be available is to adjust how pages automatically turn for a user. A user might adjust the time it takes after a passage is read until a page is turned or any other preference on the timing of how a story is read and how pages are turned.

Customizing a character, companion, or friend:

One technique in the present invention(s) is to allow a user to customize a character, friend or companion in the story.

The present invention(s) allows a user to choose the type of character that they want to read about, or a parent can choose a character that they believe their child will enjoy reading about. A user can modify the story so that instead of a story about 3 little pigs, it is about 3 little turtles, if the user prefers turtles more than pigs. These types of changes can be combined with any other user customizations. After the user chooses turtles in the options page, the story can register that change, and then present each page with text that refers to turtles instead of pigs and character images that are turtles instead of pigs. These techniques and methods can be particularly compelling in a first person telling of a story, where the user reads the story and sees images as if they are from a first person point of view (for example if the protagonist or main character has the same name as the user or the protagonist or main character is not shown, and the protagonist is different from characters), as customized characters in a story can be perceived as friends. A customized character can also be a pet. A character can be representative of a real life pet. A character can be a breed of dog or cat or any other specific real life pet. A character can be customized through a customization page to match a pet's coloring, fur type or length, body or head shape, or in any other way be made to resemble a pet.

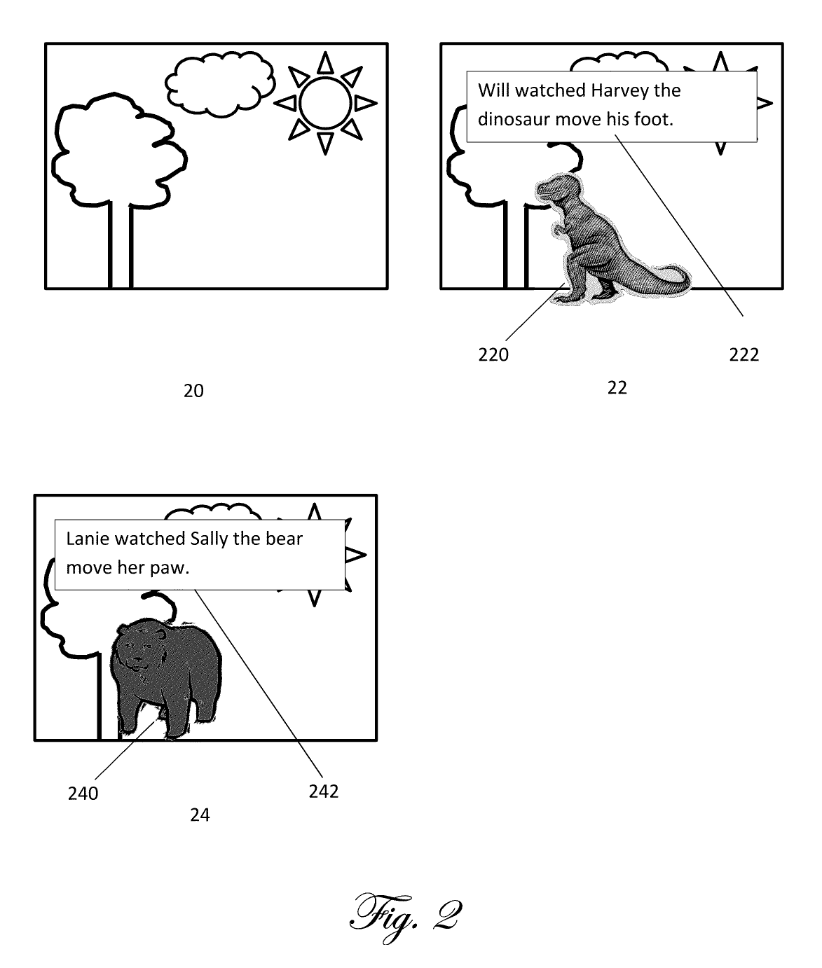

FIG. 2 shows variations of an example page that has graphics on it, with different characters overlaid on a background image and text on the page telling a portion of a story. In this example, a user can choose the name of the main character in the story, the friend character in the story, the sex of the friend character, and the name of the friend character. A background image with no characters is shown 20. The same background image with a dinosaur 220 chosen as a preference for the friend character and therefore overlaid on the background image, the main character's name chosen to be “Will”, the friend character's name chosen to be “Harvey”, and the friend character's sex chosen to be male is shown 22. The same background image with a bear 240 alternatively chosen as a preference for the friend character, the main character's name chosen to be “Lanie”, the friend character's name chosen to be “Sally”, and the friend character's sex chosen to be female is shown 24. After a user chooses their customizable elements the appropriate example page in FIG. 2 is displayed at the appropriate time as the story is read. For the image 22, where a dinosaur was chosen as the friend character, the text for the page 222 can be automatically updated based on the customized options previously chosen, to read “Will watched Harvey the dinosaur move his foot.” Because the main character's name was chosen to be “Will”, the word “Will” was inserted into the beginning of the text for that sentence. Because the friend character's name was chosen to be “Harvey”, the word “Harvey” was inserted into the text for the sentence. Because the friend character was chosen to be a dinosaur, the words “dinosaur” and “foot” were appropriately inserted into the sentence. Because the dinosaur was chosen to be male, the word “his” was inserted into the sentence. In the case of image 24, where the friend character was chosen to be a bear, the main character's name was chosen to be “Lanie”, the bear's sex was chosen to be female, and the name of the bear was chosen to be “Sally”, the text 242 would alternatively read “Lanie watched Sally the bear move her paw.” Pages in the present invention(s) do not have to have any graphics and can purely be text, or could be purely images with no text. Groupings or sets of images, characters, objects or other book elements can be inserted into a book, where a user's choices of options or customizations affect which groupings or sets are inserted instead of or in addition to other groupings or sets.

An example embodiment of the present invention(s) includes sets of characters or objects which are pre-rendered images which are inserted into a book based on a customization or customizations chosen by a user.

An example embodiment of the present invention(s) includes sets of characters or objects which are 3D models that are rendered into 2D images while a user reads a book. Background images can be 2D pre-rendered images or can be 3D models rendered into 2D images. A 2D image rendered in the book itself, or any time after customizations are set, can be further modified so that it has an effective alpha shadow, has been run through image filters, or in any other way is manipulated to fit in well in the book. 3D models can be manipulated while a user reads a book. For example, a 3D model's orientation, scale, position, body positioning, rigged bone structure, animation, facial features, or other changes utilized with 3D modeling programs can be modified. 3D models can be manipulated so that face, facial features, or body shape Is modified. For example, a human representation of a model can be manipulated by a user to look like a specific human or character or character. This 3D model can then be shown integrated into a 3D image and the scene can be rendered or converted to a 2D image and placed over a 2D background. 3D models or 2D images can also be animated, and those animations can be placed in a book or game. A 3D model that is animated and rendered into 2D frames can also be manipulated so that each of the 2D frames are modified by a filter before being used in a book or game.

An example embodiment of the present invention(s) includes sets of characters or objects where one or more of the characters are not human characters, which are inserted into a book based on a customization or customizations chosen by a user.

An example embodiment of the present invention(s) includes sets of characters or objects where the character or object images are not directly modified by a user, which are inserted into a book based on a customization or customizations chosen by a user. The sets of images used in a book can be utilized based on a single customization rather than based on a number of customizable features of that set of images.

An example embodiment of the present invention(s) includes sets of characters or objects where the characters or objects are chosen from a list of distinctly different choices rather than variations of a main type, which are inserted into a book based on a customization or customizations chosen by a user. Characters in this example can be creatures of different species, or variations of species such as breeds.

An example embodiment of the present invention(s) includes sets of characters or objects, which are inserted into a book based on a customization or customizations chosen by a user, and where the customization or customizations can lead to either a single character or object being placed on a page or multiple characters or objects being placed on a page.

An example embodiment of the present invention(s) includes sets of characters or objects, which are inserted into a book based on a customization or customizations chosen by a user, and where the choice of which character or object changes the feel or tone of the story. For example, the amount that images are changed from one option to another is more than simple variations of the same object. The perception of the story can vary by more than it would if a character had superficial changes like hair color, eye color, length of hair, or any other relatively superficial change.

An example embodiment of the present invention(s) includes sets of characters or objects which are inserted into a book based on a customization or customizations chosen by a user, and where the choice of the character or object also changes text used in the story referring to the type of character.

An example embodiment of the present invention(s) includes sets of characters or objects which are inserted into a book based on a customization or customizations chosen by a user, and where the choice of the character or object also changes aspects of the characters or objects including image colors, image sizes, image shapes, image body type, number of body parts, types of body parts, types of body covering (such as fur, feathers, or skin), or character abilities (flying, swimming, character speed).

An example embodiment of the present invention(s) includes sets of characters or objects which are inserted into a book based on a customization or customizations chosen by a user, and where the book is not presented in a 3^{rd} person representation of the user or reader.

An example embodiment of the present invention(s) includes sets of characters or objects which are inserted into a book based on a customization or customizations chosen by a user, and where the choice of the character or object automatically changes features such as hair color, eye color, fur length, clothes that are worn, accessories that are worn, or any other physical property of the character or object.

As an example embodiment of the present invention(s), if a story includes a customizable name for the main character, and a customizable character for the main companion, a parent can insert their child's name and choose a companion their child will like, making the story perceived by the child as a story about them and a friend they like. A child named Will who likes dragons can read a story about a main character named Will who has adventures with a dragon, which can make a story more compelling and more entertaining for the child. A strategy that can be utilized in a customizable story in the present invention(s) is to take preferences for a user (such as their favorite food or their age) and have both the main character and other characters, such as a companion in an adventure, have those preferences. In this way a child named Will who likes pizza, can read a story about a character who likes pizza on an adventure with a dragon who also likes pizza. This can allow a single preference in the settings for the story that applies to multiple situations and characters in the story.

An example embodiment of the present invention(s) would allow a large number of creatures to choose from as the main companion in a story. Each type of main companion might be associated with a number of images, words, other relevant customizations or any other book elements. For example, the user might choose from any number or creatures or characters such as a unicorn, Pegasus, zebra, or horse in a story where the creature is ridden; a dolphin, whale, or mermaid for an adventure in the sea; a zombie, alien, mummy, wolf, bear, skeleton, bug, dinosaur, dragon, ghost, or spider in a story that has scary components; or a princess or prince of various features with differing hair color and ethnicity for a story with regal characters. There could be two choices or fifty or any other number. These characters can be chosen from a list of possible customizable characters in a pull down menu, combo box, or list of characters with checkboxes beside them. Details of the characters can also be customizable. The user might set the character's name, sex, age, personality or any other detail whether physical, emotional, intellectual, or in any other way relates to the character. The user can also choose the type of the creature. For example, a character that looks like a large lizard can be called a dinosaur, dragon, lizard, or monster, as examples, in the text of the story in order to utilize a set of images with a label that can differ. As another example, if a user desires to read a story about a wolf, and a wolf isn't available, the user can choose a dog that looks similar to a wolf and label it a wolf for the purposes of the story. This can allow a larger variety of creatures available to a user to choose from, as the same characters can have different types or labels in a book.

One of the challenges of adjusting a character in a story that has images is then adjusting the graphics appropriately. A dinosaur character might be much larger than a ghost, but both characters are available choices for the story. The images also need to be appropriately put into the story over the background images in a way that looks good and doesn't detract from the story. An example embodiment of the present invention(s) would include a database that can be used to take any customizable features and appropriately integrate them into the story. The database can include a reference to each image that should appear on the foreground of the page for each choice of creature for each page. It can also include the position, scale, or orientation of a character, a character's body parts, or any other object applied to a 2D object or 3D object. A location and scale for each possible character for each page could be included in the database so that when characters are overlaid over or within backgrounds, they are positioned and scaled correctly and look good. Words that need to vary in the story text for each type of creature can also be included in the database. For example, in a scene where a main character looks at what a creature is standing on, the text would read ‘feet’ for a princess, ‘tail’ for a snake, or ‘hooves’ for a horse. Then those characters might ‘run’, ‘slither’, or ‘gallop’ respectively. Male characters can be used with the words he and his where female characters use she and ‘her’. The ways that characters are presented on a page can be further varied. The animation of a page or a character as a page is turned can vary per character type. Foreground images can animate differently than background images, and the differences in those animations can vary per other customizations. A ghost can be see-through where a bear is not. A lake or stream can be added to a page for aquatic creatures, so that they naturally can reside on the page. Creating and adding transparent shadows with an alpha value associated with each creature can be an effective way of overlaying creatures on the backgrounds in a way that looks realistic.

Changes in characters can also change other details in the story. For example, a customizable version of Goldilocks and The Three Bears might become Lanie and The Three Ducks. The title of the book can be changed, and the cover page or icons representing the book can also be changed, including changes to graphics or text. After a user changes the main character's name from Goldilocks to Lanie, and selects ducks instead of bears, the overall presentation of the story to the user changes. The text on the title page can change to match the new title. Images of bears would be replaced with images of ducks. Dialogue can be modified to better suit ducks over bears. Images of porridge could be replaced with images of duck food. Images of beds that fit bears could be replaced with images of beds that fit ducks.

The current invention(s) allows for different parts of a story to be customized separate from other parts. For example, a trip to the sea in a story could be customized so that the main character meets a dolphin, shark, whale, or mermaid. Later in the story, as part of a trip to a castle, the main character might meet a princess, dragon, prince, or dog. Both choices in this example, as separate options in the options page, could be completely separate and not interact with each other, or they could be related. For example, the dragon might ask the main character if he enjoyed his visit with the shark, or alternatively, the princess might ask the main character if she enjoyed her visit with the mermaid.

An example embodiment of the present invention(s) includes the ability for a main customized character or friend in the story to tell the user a separate story using audio. A parent trying to get a child to go to sleep could utilize this feature at the end of a story, where the friend in the main story tells the child a separate story, plays music or sounds, or sings a song helping the child to fall asleep. The audio can gradually get quieter further helping a child to go to sleep.

An example embodiment of the present invention(s) includes an object that a main customizable character or friend in a story gives to the main character. In the case where the main character is intended to represent a child reading a book, and the book is presented in a first person point of view, the child can feel like the friend in the story gave him or her the object. The object could, for example, be a magical or technological item that allows further storytelling or customized interactions with the user. For example, a dinosaur could give the reader, who is reading from a first person point of view, a crystal ball that works like a video phone, that the dinosaur uses in future stories or other customized versions of the story to communicate with the reader. The dinosaur could use the object to start another story by asking if the user wants to play or go on an adventure.

An example embodiment of the present invention(s) utilizes an online database to store data that is presented to the user when reading a story. For example, if the available character images are too large in size to reside on a particular device, the data, such as all the character images for a chosen character, can be downloaded to a device after the options and customizations have been set. Samples of all available options can be downloaded in order for options to be set by a user.

An example embodiment of the present invention(s) includes the choice of personality for characters. A character can be chosen to be tough, sweet, or sad, or any other personality. Character personalities can also be determined by other criteria such as reading history, an online database, a user profile, related games a user has played, or other user customizations. A character's personality can adjust other aspects of the story such as text, quotes, dialogue, graphics and storyline or other book elements. Other details of a character's history or makeup can be chosen which affect the character's personality. A character's personality can be adjusted by progress in a book, choices of storyline paths, interactions with interactive elements or interactions with any other book elements.

An example embodiment of the present invention(s) allows users to customize books, characters, or objects, and share those customizations with others. A user could share a favorite customization of a book with friends, so that they can read the book with all of the same customizations. A user could take time with a sophisticated character editor and get a character to look exactly like they want, and then share all of the values for the character editor with others so that other users can read books with the same character, and so that the character looks and acts the same in the books that utilize the shared editor values.

An example embodiment of the present invention(s) includes customizable characters that are implemented with objects that do not normally have human behaviors but in the story have human behaviors. For example, a book can be about a train with a face and can talk that tries to do his best, toys that can talk and move, or a suitcase that talks that goes on an adventure.

Customizing Plot and Storyline and Related Events:

The present invention(s) also allows for the customization of plot and storyline and related events that happen in the story. For example, a user might be able to choose between the main character attending a soccer game or a basketball game. Aspects of pages relating to that choice could then vary in the ways that they are presented to a user. For example, the main character and his companion could be shown on the side of a soccer field or on the side of a basketball court. Favorite players from either sport could be chosen for the story, and therefore integrated into the story. Background graphics can change, such as the background showing a soccer goal or a basketball hoop. Interactive elements can vary, such as a soccer ball that can be moved when touched or a basketball that can be moved when touched. Character images can change such as a character who is kicking a soccer ball or shooting a basket.

In some embodiments of the present invention(s), themes of the story can be chosen. For example, a story that is meant to help a child address fears, can be customized to the fears that should be addressed. The story can start with a main character with the same name as the child, traveling with a customizable friend. The story can then transition to any number of scenarios that children can be afraid of. In the options area of the story, a user might choose from themes such as being afraid of the dark, being afraid of making a trip to the dentist or doctor, or being afraid of thunder or lightening. The story presented to the user would have a theme and plot related to the choice. The main character can go to sleep in the dark, make a trip to the dentist, or listen to a thunderstorm, each with a happy ending to the particular situation encountered. A child reading this type of story might feel like the story is about him or her given the child's name is used. The child might feel comforted by reading the story with a companion or friend that he or she feels comfortable with or that was in other stories in a series. The child might then feel comforted that the result of the story was a nice ending to a situation that is scary in real life to the child, making the child less afraid of that situation when encountered in real life. The stories presented for each situation can have common components, such as all starting with the same beginning that transitions into the chosen situation, or the stories can all vary entirely with no common components. The plot of the story might also vary based on other choices made in the options for the story. A story with a main character chosen to be a bird might have a large portion of the storyline occur in the air, where a story with a main character chosen to be a fish might have a large portion of the storyline occur under water. Storyline, plot, or themes can be varied to include other types of events, activities, or hobbies, such as a themed book about sewing or knitting, a themed book about going to school on the first day of school, going through a divorce or dealing with a death or other similar difficult situations to help children cope with a situation, playing games or sports, visiting a location or monument, going on an adventure, physical activities, taking part in a holiday, or any other type of situation, setting, activity, or event that has interest to a reader.

In one example embodiment of the present invention(s), the purpose of the story can be to help a child overcome real life fears. An item or creature that the child is afraid of, such as spiders, can be one of the choices for a character in the book. A child who is scared of spiders can then read a story from a first person point of view about himself going on an adventure with a spider, where the spider is nice and the main character finds that there was nothing to be scared of. This type of story can also include other strategies to overcome fears such as a customized character or friend in the story instructing the reader to take deep breaths or count their slow deep breaths, the creature can keep watch over the child if the application is left on, it can spray or provide parents with a recipe for ‘monster spray’ that can be sprayed to protect the child, the friend can instruct that the reader should be brave, the friend can play soothing music or read or sing, the friend can instruct the reader to think of a calm place like the beach, or the friend can help calm a child or ease fears in other ways.

An example embodiment of the present invention(s) is a story of either a hero or princess that goes on an adventure. The choice of a hero as the main character can modify the plot of the story to better suit boys, where the choice of a princess modifies the story to better suit girls. A hero can fight his way past a dragon to discover treasure where a princess can save an injured dolphin. Components of both stories might be the same, such as background images of a forest, a wizard who helps either character in their quest, or a celebration party at the end of the story. Alternatively, either story might be completely separate with no shared components. Other types of customizations can similarly show preference for gender. The gender preference can adjust the available characters, plots, background images, music, or any other book elements. Prince or princess characters, or other human characters, can be adjusted using a character editor that modifies body shape, face shape, facial features, hair color, eye color, skin color, or any other body feature. These customizations can be utilized to make a character look like the user or they can be utilized to make a character look like another real life person or a fantasy, make believe, or fictional character.

The present invention(s) also allows for the customization of text in the story to suit a user's reading preferences. For example, a user might select a reading level as a customizable component. The reading level selected would then adjust the text shown on each page. A reading level of 6-7 year old might include text with more complicated themes and motivations compared to text in a 3-4 year old reading level. Each of those reading levels, plus any number of additional reading levels and reading level ranges can be available options in the option screen. A database for the story could include the text that is used on each page for each reading level, including how that text is adjusted by any of the other customizable options for the story.

In an example embodiment of the present invention(s), a user can change a setting so that the story is longer or shorter or has a different number of pages, such as a parent who wants a quick night time story one night versus a longer story another night. Another option can include the ability to lengthen the story at the end if the parent wants to continue reading to the child. The option to have this ability or not can be included in the options page, and then the parent or user can make the decision on whether to use the ability or not when the final page is reached. When a last page is reached, the book can utilize a subtle indicator such as a sound or graphical indication. A parent reading to a child can use a number of techniques to indicate that a book should either continue or end, such as a button, a swipe, clicking an area of a page, a multi-finger touch, a multi-finger gesture, or any other type of user interface component. A book can also have the ability to have a time limit. When a time limit is set it can be utilized in a number of ways. The book can turn off, or gradually turn off when the time limit is met. A book can lock when a time limit is met. A book can have a preset interaction such as “exploding” where the graphics would shake and a sound would play, or any other type of interaction. The story can adjust itself so that it can approximately meet the end time by adding pages or content if the reading is progressing quickly or removing pages or content if the reading is progressing slowly. Characters or other objects can change in their appearance or interactions based on a time limit. For example, a character can say that “it is almost time for bed”, or the book might give a user a visual or audio warning.

A user might choose the presentation of a story so that the text of the story rhymes. A user might choose the presentation of a story so that two types of text are shown, the first that a parent reads to a child, and the second that the child reads to a parent in return, creating a fun interactive type of interaction while reading. A user might choose a story style that has humor and jokes integrated into the text, or varying types of humor that are appropriate to different ages or different humor preferences. A possible choice for text preferences can be a reading level that is geared towards teaching a user how to read at varying proficiency levels. Preferences can also be included to have the text match up with school curriculum. All of these types of customizations can be combined. A rhyming story can have differing reading levels, and a you-read-to-me-I-read-to-you story might also have differing reading levels or might rhyme or not. The choice of presentation or other book elements can change the font, size, or other display features of text. For example, a lower reading level can increase the font, or text passages that are long because a user chose long names might be decreased in font size to better fit a page. The text in any given presentation might vary based on other customizations. For example, rhyming text might need to be lengthened or shortened to allow for character names or labels that are longer or shorter, so that the rhyming or poetic structure maintains its rhythm or balance.

One embodiment of the present invention(s) allows a user to choose between simply reading a story or making it a more interactive experience. The options page might have a choice such as ‘reading’, ‘shrinking’, ‘change to cats’, or ‘games’. If ‘reading’ is chosen then the story can be presented as a standard story. If ‘shrinking’ is chosen, then the story can be presented as the user has received a shrinking ray gun which can shrink things. The text of the story can change, though it does not have to, and the user can touch or click on various objects on each page, which when touched, shrink to a smaller form. Similarly, if ‘change to cats’ is chosen, then objects that are touched can change into various types of cats. For example, the user can use a morphing ray gun and change trees, plants, park benches, other animals, or any other objects into cats, or in a similar embodiment, into any other object. If ‘games’ is chosen, the story can have interactive games on pages in lieu or in addition to a story that is told. Examples of story types include standard reading with all the other embodiments described elsewhere in the Specification; changing properties of objects such as their shape, size, or type; simply interacting with characters; finding hidden objects; changing the scale of characters' body parts, or adding in any type of game or interactive situation in lieu or in addition to pages. The different story types can also be related. For example, the main story mode might describe how the character gets a ray gun or magic wand, which can then be used in other modes to play the games or enjoy the interactivity. Any components of any mode, such as background images, character images, text or any other story item, can be used in multiple modes.

In one example embodiment of the present invention(s), a user can make choices during the story to adjust the flow of the story or of the plot. Historically, this concept has been used in a number of books, such as the Choose Your Own Adventure series, where the reader makes a choice on a page such as turning right or left at a fork in the road, and based in that choice the book takes the user to different pages and therefore a different plot or storyline. The user can therefore choose from a variety of paths to take in determining how the story progresses. In the present invention(s), however, the user can set preferences in the options screen that adjust which plot options and paths are available while reading the story. A user might choose to have a more mature or scarier version of a story available or a less mature and less scary version available. Based on this choice, certain paths in the story can be made available or can be removed from the current set of available choices. Paths in the story can be adjusted by other customizable features. For example, a story that includes a Pegasus might have an option to go through a forest or fly over it, where a story that instead includes a mermaid might have the same option to go through the forest, but an alternative option to swim around the forest through the sea. Paths and other book elements can also be enabled, disabled, or created based on an online database or a user profile.

Allowing the customization of plots and story lines can have a number of advantages. It can create a strong sense of value for the purchase of the book, as a parent buying a book for a child can feel that they received a number of stories or interaction modes in a single purchase, or stories that are enjoyable for more than one of their children. It can also allow a user to feel that they are getting a much broader and larger amount of content than the same amount of development effort would otherwise allow, given the re-use of components of the stories that overlap. It allows a wider variety of stories to be sold, which is particularly true when combined with other elements described with the present invention(s). For example, a customer could buy an entire series of stories about a turtle, where another customer could buy an entire series of stories about a rabbit, and both customers bought the same books, but simply customized them differently. Each of the books in the series could include any number of plot lines within the book that also vary by customizable options.

Customizing Elements:

The present invention(s) allows the customization of story elements such as interactive elements or objects, sounds, music, or other story elements. For example, a parent reading a story to a young child might want the story to be less scary. The options page for the story can have a choice between ‘standard music’ and ‘less scary music’, and when the ‘less scary music’ option is chosen, the story can be presented with music that is less ominous and sets a lighter mood than the standard music. Similarly, a user might want to customize music within the context of the story to give the story more variety or a better desired effect. A user can choose favorite songs that play in the background while reading the story so that the music does not become monotonous. Background images can be modified to create a different feel. A filter can make a background darker or more ominous. Lightning, fog, lighting, or clouds, as examples, can be added into a background.

In one example embodiment of the present invention(s), a parent might want to read a story to their child to help them fall asleep. At the end of the story, a character might end the story by saying “let me play you a song now to help you go to sleep”. Then a song can start playing, and the parent can leave the story running, playing the song. The choice of which song plays can be a customizable option in the options screen. Another embodiment of the present invention(s) would allow a user to integrate any number of songs from an online database into the story. Another embodiment of the present invention(s) can allow a character or friend, or the book, to play to the user ambient noises, white noise, or any other music or sounds that can help a user go to sleep. A user can customize the duration that songs or music are played.

In an example embodiment of the present invention(s), a user might want to adjust how the story is presented to better suit the processor speed or simply user preferences. For example, a user might turn off interactive elements in the story, such as objects that move when they are touched, so that the user can focus more on the story and not be distracted by elements that are unwanted or that do not perform well.

An example embodiment of the present invention(s) can allow the integration of interactive elements in the book, downloaded from an online database.

An example embodiment of the present invention(s) can allow a user to choose which interactive elements appear on any given page.

An example embodiment of the present invention(s) can allow a user to modify and customize interactive objects and elements in a book. Interactive elements can be implemented with simple animations and sounds that are activated when the user touches or clicks on them, or the interactive elements can be complicated physics based interactions. For example, an interactive element on a page can include a number of objects that can be moved or manipulated, and then a ball or other object that interacts with all the other objects, utilizing physics calculations. This can be utilized to create a puzzle or simply as a fun interaction, as examples.

One example embodiment of the present invention(s) includes a page turning technique that allows a user multiple ways to change a page. A user can click and drag, or alternatively swipe, the page to start a page turning, and see an animation that makes it look as if the page is turning. The user also can push an arrow button or other icon to turn the page, also seeing the animation. In the options page, the user can choose whether the swipe method, the button method, or both are available to move between pages.

The present invention(s) allows interactive elements to be modified based on other customizable choices. For example, a user who chooses a monkey as a primary character might have interactive banana objects throughout the story, where the choice of an elephant might have interactive peanut objects throughout the story.

The present invention(s) allows the ability for a user to add a picture or drawing to be included into the story. For example, if there is an object that is a favorite item of a child, a parent might take a picture of that item, upload it into the application, and then place the object on a page. An object might be run through a photo filter to fit the background it is being placed on top of. Pictures of people (of others or of the users themselves) can be added into stories. A user might take a picture of their face, move and scale it to fit in a windowed area to get the right size and then the application can utilize that picture in the book. A filter can be used to integrate an image of a person to fit the background images of the book, or to match with filters used on other characters images in the book.

An example embodiment of the present invention(s) includes a book with any number of interactive objects on each page, ranging from zero to one to any other larger number. A user can customize how many interactive objects and what types of interactive objects are on each page. Interactive elements include anything a user can interact with. Interactive elements can change when they are touched or clicked on, can change when touched or moved by other objects controlled with a physics system, can change based on timed events, or can change in any other way. They can change in shape, size, type, scale, orientation, or any other feature of theirs can change based on the interaction with the user. They can change graphically, sound or music can play when they are interacted with, they can have haptic interactions with a user when they are interacted with, they can have smell or taste representations from an external device when interacted with, or can be presented to a user in any other way. Interactive elements can be related to any book element. Examples of interactive objects that can be interacted with include, without limitation, physics systems, a refrigerator or closet or cabinet whose door opens, kitchen appliances that can be turned on, dirt that turns into flowers or other plants, a garden with vegetables and plants that pop up, a dog that barks, a cat that meows, a hot air balloon that floats off the screen, a swing that moves, popcorn that pops, a bee that buzzes or flies, a butterfly that flies off the screen, a tree or any other plant that moves or blows in the wind, an airplane that flies with a smoke trail, a ball that rolls, a mouse or chipmunk or other animal that walks or eats or performs an action, a cricket or grasshopper that hops off the screen, a ladybug or other bug that flies off the screen, a hamster or turtle or other pet that you can interact with, an ant or other bug that crawls on something, a dolphin or other sea creature that swims, a car or vehicle that makes a horn sound or drives, objects that morph into other objects, objects that can be rotated or turned upside down, a rainbow that pops out, clouds that float away or turn into a shape, a kite that flies away, a balloon that floats up, objects that are hidden and can be found, a radio tower with lights that begin blinking, a sign or object that wobbles, a windmill that turns, a horse that neighs or any other animal that makes an animal noise, traffic lights that change, street lights or other lights that turn on, a house doorbell that rings, a gate that opens, a porch light that turns on, any creature you can put a hat or glasses or braces or other feature on, instruments that can be played, an egg that hatches, a bunny that hops away, objects that shrink or grow, objects that change color or disappear or appear, eggs that a user can color, objects a user can paint or color, bubbles that pop, bubbles that can appear, ice cream or an ice cube or anything else frozen that melts, food that can be eaten, water that flows, apple tree that drops apples, a tree that drops leaves or any other object, a firetruck or other vehicle with a siren that turns on, a train or other object that pulls away, a spider that crawls away or climbs its web, an inchworm that inches along, an electronic sign that changes, a flag that blows in the wind, clothes that can be put on a character, walls or a canvas that can be painted, nails that can be hammered in, food that can be prepared and cooked, wigs that can be placed, objects that appear when an area is clicked, a net that can catch butterflies, Bubbles that can pop, a dust devil or tornado that appears in the background, items that you can shake including by shaking a device.

Development Efficiencies:

Embodiments of the present invention(s) can allow a much larger amount of content to be enjoyed by users than is typically available in a traditional book. There are a number of techniques used in the present invention(s) in developing the customizable books that allow that broader range of content to be developed.

One of the techniques used in creating a book with background images is the standard technique of an artist hand painting or drawing images that are then included in the book. Books can include images with characters and objects that are not customizable, and can include in those images, positions where customizable characters and objects can be placed. Another method of creating backgrounds is to use photos. Another method of efficiently creating backgrounds is to take a photo, and then filter that photo so that it looks more artistic and less like a photo. For example, a Photoshop Dry Brush filter applied to a picture makes the picture look as if it was painted. In Photoshop, a layer with the original image can be created. A second layer with the same image can then be created on top of the first layer. The bottom layer can have a dry brush filter applied to it, so that it loses some detail it had, making it look like a painting using a relatively small brush. The layer above that can have the same dry brush filter applied to it, so that it loses more detail than the bottom layer, making it look like a painting using a larger brush with larger brush strokes. Then a mask can be applied to the top layer (or pieces of the top layer can be simply cut out), letting the bottom layer show through, on areas where more detail is desired. Choosing interesting pictures as a starting point can add an artistic flare to the story. Utilizing the same image, but zoomed or positioned differently, or with another photo editing effect applied to it, can create a larger number of usable backgrounds quickly. These changes can be made before or after applying an artistic filter. Similar to utilizing a photo image for a background, a 3D background image can be rendered in a 3D modeling program to create a background. It can then be taken through the same process as a photo to give it a similar feel as the modified photos. Normally, a 3D rendered image and a real life picture would be too different to be utilized as images together in the same book, but by utilizing the same filtering technique on both, the images can be used together in the same book. Then, foreground images can be placed over the background. These foreground images can be characters or any other type of object. A foreground image can be created so that it looks good over the background image by processing it with a filter as well. The filter or filters can be the same ones or same techniques as those used on the background, or they can be different filters that make the foreground objects stand out more, such as a Photoshop Poster Edges filter. If a designer creating a book using the present invention(s) wanted to create a dog as a character for a page, he could take a picture of a real dog, a stuffed dog, or a figurine or statue of a dog, or use a model of a 3D dog in a 3D program, and then take a 2D image of the dog and utilize a filter on it to get an image that would look good over a background. A 3D modeling program can be used to create the background and foreground images with or without using any additional filters. 2D images from a 3D model can be pre-rendered or can be rendered after a book is bought.

In an embodiment of the present invention(s), many different characters are desired to be options in the options page for a character in a book. The classic book “Little Red Riding Hood” might have an option for the main character to meet up with a big bad rabbit, deer, elk, horse, pig, or wolf. A story with many characters and many pages each with the chosen character can lead to hundreds of images that need to be created for the book. A database of which images are used for any given option and where each image should be located on each page can be utilized so that the book presents a consistent set of images to the reader. Creating the images and having them blend against the backgrounds seamlessly can be a challenge. One method of creating many character images is to model the characters in a modeling program, and rig those characters so that their joints can be moved and they can be positioned into any pose or expression. The camera utilized in the 3D modeling program can be positioned to get the correct viewpoint for a character in a needed shot. Then a 2D image of each character for each page can be rendered from the 3D models along with an appropriate lighting model, appropriate textures and other techniques standard to 3D model rendering. There are a number of techniques that can be used to make the rendering process quicker. The characters can be set up ahead of time so that their eyes always follow the camera. Different lighting models can be saved so that each character looks like it was in the same lighting and that lighting fits with the background image the characters will be placed on. Many different poses can be preset and saved so that when an image is needed, a preset pose can be recalled and modified. After all of the 3D models are rendered to 2D images, all of the 2D images can then be filtered to create images that look good over any given background. This can be done as a batch process. The 2D images can then be scaled and placed onto the backgrounds in order to create the database of where each image should be positioned if it is shown. One technique that is particularly useful in making the 2D character images look natural over a background image, is adding shadows underneath the character. Background images can be chosen so that there are flat areas for characters to stand. When a character is rendered in the 3D modeling program, a shadow can be created as part of that rendering. A shadow can be rendered separately from the character itself, for example by making a strong light source very far away and directly above the character, and then moving the character out of the view when rendering. A shadow can be rendered in this way onto a flat ground, or a ground made to mimic the ground for a background, and the ground can have an alpha value, so that the resultant shadow rendering also has an alpha value. A photo editing program can be used to clean up the shadow, so that all that remains is the shadow itself, with the alpha (see-through) value. The edges of the shadow can be softened or in any other way manipulated so that it better fits within the context of the background. Then, the shadow can be recombined with the 2D filtered character (where the shadow is not necessarily filtered itself, as that can cause unwanted effects), and when they are together placed over a background, the character's shadow can make the character seem to actually reside in the background in a 3D way. Another technique that can be usefully applied, is to make adjustments to the 2D images to give the characters emotion, expressions, or in any other way modify the look of the character to fit the page it is to be used on. For example, eyebrows can be used to give a character emotion, and the eyebrows can be added to the 3D model before it is rendered, to the 2D rendered image before it is filtered (the 2D images do not have to be filtered, though), or to the 2D model after it is filtered. Using these techniques, large numbers of creature images can be created quickly, and therefore large numbers of options can be presented to a user. Those skilled in the art of animation, modeling, and photo editing will understand natural variations of these example techniques.

In an example embodiment of the present invention(s), a book can be created with many more background images than there are pages in any particular presentation of a story within the book. There can also be a large database of possible placements of all of the possible characters on any given page. There can also be a large database of possible plots for any number of stories, and all possible plots can be grouped and chosen through options presented to the user on the options page. In this type of situation many different stories are possible within the book. For example, if there are 30 backgrounds, 11 possible characters, and 10 plots, each of the plots might use 12 of the 30 pages. Each plot can use a different 12 pages than any other plot, but many plots will use the same background pages. A user can make choices on the options screen and read a story about a rabbit traveling to a castle in the forest. A second night, the user might read about a rabbit traveling to the beach near the forest. A third night, the user might read the same plot as the first night, but with an owl as the main friend in the story instead of the rabbit. A fourth night the user might read a story about a dragon that travels into space. Each of the stories read can have a great deal of overlap with the other stories in terms of backgrounds, plots, and character images, or they can be unique with no overlap, or they can be somewhere in between with only some overlap. One method of presenting stories to users would be a randomizer that randomly chooses options for the user. The randomizer can choose simply between plots and characters, for example, or it could pick random values for all options available to a user. Customizations available to the user can include art style. For example, a user can choose between a style painted with oil, pastels, or acrylics, or styles like Disney animation instead of highly detailed fine art.

Multiple Stories and Games and User Databases:

One of the goals of some embodiments of the present invention(s) is to create multiple books or stories and utilize techniques where a user reading from different books (for example, books or stories purchased separately) has a level of familiarity between those books. For example, a parent who has a child who is very interested in dinosaurs might buy a book created with the present invention(s), and customize it to later read to their child. The parent might give the main character their child's name (for example, Will), and then pick a dinosaur as the main friend in the story, and name that dinosaur the same name as the child's real life stuffed dinosaur's name (for example, Harvey). A second book bought by the parent could then take the same preferences used in the first book, and apply those preferences automatically. This can be accomplished through an online database where the parent would log in and set preferences, or it could be accomplished with a database on the device used to display the book itself, as examples. Any potential options could transfer from one book to another, or the parent could indicate which of the preferences should translate across different books. Names for characters can start with defaults that are consistent across books unless those names are changed by a user. The parent purchasing the second book could then open it, and it would have default settings already applied, with their child's name, Will, as the main character, the same dinosaur, Harvey, as the friend. Entire series of books can be customized to any given user's preferences, and the books could be consistent across the series. In this way, for example, parents with children interested in bears could find many books about bears, where parents with children interested in unicorns could find just as many books about unicorns (e.g. the same books with a different customization for that character). An online database can have social components. Users can indicate to each other books they like through an online site or through common social networks like Facebook. Users can share books they customized with other users or with friends and family. Users could vote on requested features for new books, or requested new characters for options to be added to existing books or new books. Users can save references to their favorite parts or pages of books and share those preferences with others or simply refer to those preferences later themselves. Any book elements that are described to be able to be utilized within another book, game, or application, can refer to a single instance of the element, can refer to a set of data representing the concept or element, or can refer to customized versions of the book elements and can include all of the customizations related to the book elements or concepts. For example, an example that describes that a dinosaur can be included in other books can refer to an image of the dinosaur; a collection of images of the dinosaur; all images, sound, text and personality customizations related to the dinosaur, or all data related to the dinosaur.

An embodiment of the present invention(s) includes a user profile that is utilized in modifying book elements. A user profile can be maintained within a book, within a master options screen in an app that contains many books or stories, or online, as examples. The user profile can include interests, personal details, favorite music, favorite movies, where a user lives, what type of environment a user lives (such as country vs city), or any other personal details for a user. For example, a user's interests might affect which scene is displayed during a portion of a story. When a user is creating a profile, specific options can be presented to the user to fit available options in a book or a series of books. For example, an option for a favorite sport might include basketball, soccer, or football, and that choice might affect the storyline of a story. Books can be customized by items in a profile or by the lack of information in a profile. For example, if a profile does not include a preference for a sport, a scene that can take place with a choice of 3 different sports can just be set to a default sport. Text describing a user in a first person version of a book can be modified by user preferences such as the color of the user's hair. If the user's hair color is not described in a profile, though, the text can generically refer to hair instead of the color of the hair. A user profile can adjust which options are available in an electronic book. This can allow a simpler user interface for a book's options screen, or can eliminate options that users know they will not modify.

An embodiment of the present invention(s) can allow users who have set preferences in a database to use those preferences in games or other applications as well. For example, a user might customize a story to be about a monkey named Mono. The user's preferences can be saved on an online database, including the preference for a character to be a monkey and to have the name Mono. Then the user can read about adventures involving Mono the monkey, and grow fond of the character. A user wanting to buy a tic-tac-toe game might then purchase the game from the same developer that made the book that included Mono the monkey, and play tic-tac-toe against Mono the monkey. Another tie in between books and games can be an object a character gives to a user reading in a first person point of view. The object can be a crystal ball, for example, and the crystal ball can be used by the user to play any purchased games. Similarly the crystal ball can be used to read any purchased books, as a customized character can ask the user to read or can directly ask the user if he wants to go on an adventure. Any preference can be applied between books and games. Reading levels can affect game difficulty, for example. Plot preferences for a story can show up in a game. Character names and preferences can be utilized in a game to make it more familiar. One of the strengths of methods used in the present invention(s) is to create a connection between a story and a reader, and that connection can be applied to other games and other applications.

Example embodiments of the present invention(s) include a variety of interactions between books, which tell stories with text and/or pages, and games which do not tell stories with text and pages. Relationships between books and games or methods or techniques described with books or games in this Specification can be implemented with customizable books and customizable games.

While reading a book or game, users can get or unlock tradable items that can be traded with other users.

Interactions with characters in a game can adjust characteristics of the same or similar character in a book, such as personality, physical features, clothing or any other feature. Similarly, interactions with a character in a book can affect the same or similar characters in a game.

Interactions, preferences, or progress in a book or series of books can adjust a game, or interactions, preferences or progress in a game or series of games can adjust a book. Users can unlock, find, open, enable, affect, or adjust a number of book elements or game elements, such as features, powers, levels, hidden content, characters, storylines, plots, plot paths, objects, customization options, character outfits, clothes, accessories, character abilities, interactive elements, storyline paths, or any other book elements or game elements

Options in books and games can be largely similar, or exactly the same.

Games can be purchased separately and integrated into a book or a book's storyline.

Content from a book can be included or utilized in a game, or content from a game can be included or utilized in a book. Customization choices for characters can be shared between books and games, including concepts such as visual appearance, personality, or type of character. Items you build in a game can appear in a book. For example, a castle a user builds in a game can appear in a book. A storyline in a book can be integrated into a game. Items obtained in books can be used in games or items obtained in games can be used in books. For example, a character in a book can give the user a sword, and that sword can be used in a game. A user can get a car in a game and the car can appear in a book. A character or object from a book can be used as an object to play a game. For example, a dinosaur customized in a book can become a character that is shot with a slingshot in a game. A character's image can be overlaid on a game's images without having access to the source code of a game, to create links between books and games owned by different publishers. A customized character from a book can help a user play a game, give hints, or be a companion in a game. A customized character in a book can become an interactive creature in a game or entertainment application. For example, a user can interact with the book's character and feed it, take care of it, bathe it, pet it, exercise it, play with it, or interact with it in any other way. Customizable characters from books can interact with users in online worlds. A user can play a game as a customizable character from a book. Games can be played in customized locations from a book. Users can fight against or play against customized book characters. Clues to game puzzles can be found in a book. Music can be transferred between books and games, including how it was customized. Books can be found in games, which can later be read. Sample images or objects from a book, including images or models created from customized objects or characters, can be utilized in a game. Books and games can share environments, including customized environments. Board games can utilize objects and characters, including those that were customized, as game pieces. Key words from a book, including those that were customized, can be used in a word based game such as a word search or a word building game. Objects from games and books, including customized objects and characters, can be hidden in other games and books. A customized character from a book can be a referee in a game. Game environments can be adjusted from customizations in a book. For example, if a dinosaur is chosen as a character in a book related to a game, the game can have a prehistoric setting.

An example embodiment of the present invention(s) includes game Artificial Intelligence being adjusted from preferences set in a related book.

Book achievements and game achievements can be combined. For example, an achievement might require a user to perform actions in both a book and a game.

Customized characters can appear in applications other than books or games, such as a personal assistant in an application, a character in an entertainment application, a movie or video, or in any other application.

Physical representations of customized books can be created and sold. Physical representations of customized characters from customized books or games can be manufactured and sold.

The ability to buy games or books can be unlocked by interactions, preferences, or progress in other games and books. Interactions, preferences, or progress with books and games can also allow a user to earn or collect virtual cash or credits that can be used to buy other book and games or other book elements. For example, each book read, interactions with interactive elements, games played, characters used, customizations made, or any other type of interaction with a book or game can lead to virtual currency being earned. A currency system like that can also be combined with the ability to actually buy the virtual currency with real life money, such as US Dollars or any other real currency.

One embodiment of the present invention(s) can allow a user to set preferences for multiple readers. A user can indicate which reader they are by choosing a login name, choosing their name from a pull down list, or other similar type of chooser, and then all of the preferences for the book for that reader will be available. A different reader can set and save different preferences, and also bring up those preferences later. The preferences for different readers for any given book can be stored locally on a device showing the story, or in an online database. A parent with multiple children can use this technique to save settings for each child.

An embodiment of the present invention(s) can allow a standard non-customizable version of a book to be purchased or perhaps downloaded for free, and then allow a user to purchase the ability to customize the books or stories. Purchases can be made in an online store or within the application itself, as examples. A user can purchase additional characters, additional storylines or plots, additional reading levels, additional interactive elements or in-story games, or any other book element described in this Specification.

An embodiment of the present invention(s) can allow a user to set preferences on characters they like in individual stories and have those characters be combined in other stories. For example, a user might enjoy reading one story about a dinosaur and another story about a mummy, and then enjoy other stories with both the customized dinosaur and mummy interacting together.

An embodiment of the present invention(s) can allow text or images to be incorporated into a story from an online or on-device database, not accessible to the user to modify directly. For example, if a user chooses that the storyline should include a trip to a basketball game versus a soccer game, real life basketball player names and images can be incorporated into the story.

An embodiment of the present invention(s) allows the appearance of three-dimensional images from a device that does not have a three dimensional screen. An object displayed on the screen, or portions of an object displayed on the screen, can have a height above or below the screen level associated with the object. Then a user can tilt or move a device such as a phone or tablet, which is registered using accelerometers or any other method of detecting tilting or other movements. Based on the tilting or movement of the device, the object or components of the object would move differently based on the height associated with the object. For example, objects further from the screen can be made to move more than objects closer to the screen. The perspective of objects can change as well. For example, if a user is looking at the top of an object while a phone is flat, a top view of the object can be displayed. If the phone is then tilted where the right side of the phone moves up, the object can be rotated so that the right side of it can be seen, as if it was sticking out of the screen and had been rotated along with the phone. A device's rotations can also be made to appear as if it is acting as a window looking at object below the screen. The objects and their representations or implementations, such as vertices for a 3D model, can move differently based on their height below the screen as it is rotated. These effects can create a parallax effect which gives the perception of a 3D display. These 3D effects can be used to make an electronic pop-up book appear to have graphics that are actually 3D and more like a real life pop-up book. A page opening can make the objects on the page appear to rise above the screen given the movement of the page turn.

An embodiment of the present invention(s) includes the ability for measurements of movement of a device displaying a book, such as the amount it is tilted, to modify the book or a book element. For example, a phone that is tilted can cause a page to be turned.

An embodiment of the present invention(s) includes haptic (e.g.) touch, smell, or taste interactions with a book or book elements. For example, a page turning can create a haptic effect for a user, so that the user feels the page turn. A page that has a scene in a grass field can trigger an external smell producing device to emit a grass smell. Any type of book element can trigger interactions with any of a user's five senses. Interactive elements can have haptic interactions associated with them which can be trigger when the user interacts with them. Haptic interactions can indicate book state or other book events. Three dimensional objects in a customizable book or game can have haptic representations, so that the objects are touchable in 3D with a 3D haptic device. Objects can have physics interactions applied to them where haptic representations of the physics interactions are transmitted to a user using a haptic device. Motors can vibrate or actuate to provide the haptic feel, or other actuators can be utilized to create a haptic feel. External devices can create smells or tastes, in addition to standard graphics and audio. For example, haptic sensations from a motor can create a sense of touch that a page is turning similar to how a page turning would feel with a physical book. An electronics device separate from the device that the book is shown on can have haptic interactions with the user to create haptic interactions with a user while reading a customizable book, or the haptic actuators can be embedded into the device the book is being read on. Haptic devices utilized with a book can be grounded on a desk or can be worn by a user such as with an exoskeleton or actuators attached to something a user wears. All of the haptic, smell, or taste interactions can be customizable in an options page.

A book can be implemented with a head mounted display that lets a user view the images associated with the book through the head mounted display. The head mounted display can include head tracking and body tracking which would allow a user to look around and move around within a virtual environment associated with the book.

An embodiment of the present invention(s) allows for advertising. Ads can be integrated into a story. Preferences and customizations for the book can modify how ads are placed and presented. Characters can utilize objects or products that are intended to be advertised and can help to make an ad more effective. Object products that are intended to be advertised can be integrated into a story's images or text. Storylines can include areas utilized for advertising, and storyline paths can modify how ads are presented. Online profiles or databases utilized to customize a book can also modify advertising.

An embodiment of the present invention(s) allows a camera to be utilized in creating images for a story. The camera can be utilized to take pictures that are then incorporated into the story, and preferences in the options screen can adjust how those pictures are incorporated. A camera can be used to show a user in the story in a first person view, such as by utilizing an image or images taken from a camera, including a real time live feed from the camera, and showing the user in a mirror in the book.

Example embodiments of the present invention(s) include variations on how books, games, characters, and other book elements and game elements are sold and distributed to users. Books can be grouped into a related series that share characters or other books elements that are consistently available options across all books in the series. For example, a book application could be marketed as a collection of classic books, which are customizable. A collection of classic stories, such as Goldilocks and the 3 Bears, Little Red Riding Hood, Snow White, The Little Mermaid, and any others can be grouped into a single book that can then draw in users and views (e.g. page hits in a search) for users searching for any one of those stories. Then customizations can be applied to all of the characters in all of the included stories. For example, a main character chosen to be a dog could then be implemented in all of the books in the series so that all of the books in the series have a dog, and related dog images and text, implemented as the main character in the story. A master customizable options page can be applied to all of the books and then all of the books can have their own options pages that take information from the master option page and let a user further customize the individual books. The master options page can give a user the ability to set a preference to set a character as the main character or the main companion character in all of the stories, and individual stories can override that setting for the single story in its options page. An individual book's options page can include the option to utilize the master option setting or an overriding setting.

An example story in this example embodiment would be Jack and the Beanstalk. The user might set a preference in the master options page for a dog named Buddy, that resembles a real life pet dog named Buddy, to be the main character in all of the books and customize that character to be just like the real life pet, and the specific book could then become Buddy and the Beanstalk. Images of Buddy and text relating to Buddy can then be utilized in the book as it is presented to a user. Even if the main options page has the main character set to be Buddy, a user can further adjust the specific book, and set the main character for that book to be a famous licensed character such as Batman, making the book Batman and the Beanstalk. In that case, images and text relating to Batman would be utilized in the book as it is presented to the user. Books can be chosen to be in various forms to change the point of view or main characters in relation to customized characters. For example they can be first or third person form, with any choice of character to be the main character or a companion character. A user named Will can customize the story to be Will and the Beanstalk. The character Will might be accompanied by Buddy or by Batman. Alternatively, the user can customize the story so that either Buddy or Batman is the main character and is accompanied by Will. Multiple characters can also be utilized in a book. Buddy and Batman might together act in the same way a main character alone works in a different customization, or Buddy might accompany Batman, as examples. These methods and techniques can be utilized with other books beyond classics or public domain stories.

A collection of books, such as a classic books collection, can be given away for free with some stories or other book elements for sale, or a user can pay one price and get access to all of the books in the collection. Characters or other book elements can be consistently available across all books in the collection even if not grouped into multiple series. Books with propriety or non-public domain storylines can be included in an application marketed to include all of the classic stories, and can be customized in the same ways that any other collection of books can.

A sales or distribution system can indicate which books are available and which books have already been bought or downloaded. In an example embodiment of the present invention(s), the system can indicate that versions of books are available to be downloaded for free which are not customizable, or which books can be purchased where they are customizable. The system could allow the free download of games that are not customizable, or allow the purchase of games that are customizable. After a book or game is downloaded, the distribution system can then describe that the user can read or upgrade the book, or play or upgrade the game. Upgrade indicators, such as an upgrade button, can be included directly within books or games as well, which can allow the purchase of additional book or game elements and customizations. The system could also indicate to a user which other book elements, such as characters, storylines, reading types, additional interactive elements, or any other book element, are for sale. Books, games, book elements or game elements can be for sale using virtual currencies or real currency.

An example embodiment of the present invention(s) includes a purchase system where non-customizable books and games are available for free, customizable books and games are available to purchase, and characters are also available to purchase. In this example embodiment, a character that is purchased can be available to be used with any customizable books, or they can be specified to only be available with a subset of books or they can be specified to be available to a single book that must be chosen when the character is purchased. For example, a famous licensed character like Batman might need to be sold separately for each book that character can be used with, but other characters can be purchased and when purchased are available for all books with that single purchase. The sales system can also specify which purchases are available on which platforms. A purchase can make a book available to use both on an iPhone and an Android device; just an iPhone, PC and Android device; or any other combination. Using this technique, a user can do one set of customizations that are stored in an online database, for example, and utilize those customizations across books displayed on different platforms. Any given platform device can download only the books and games that were purchased for that platform, and only the content, book elements, and customizations that are available for the given books and games.

Other Example Embodiments

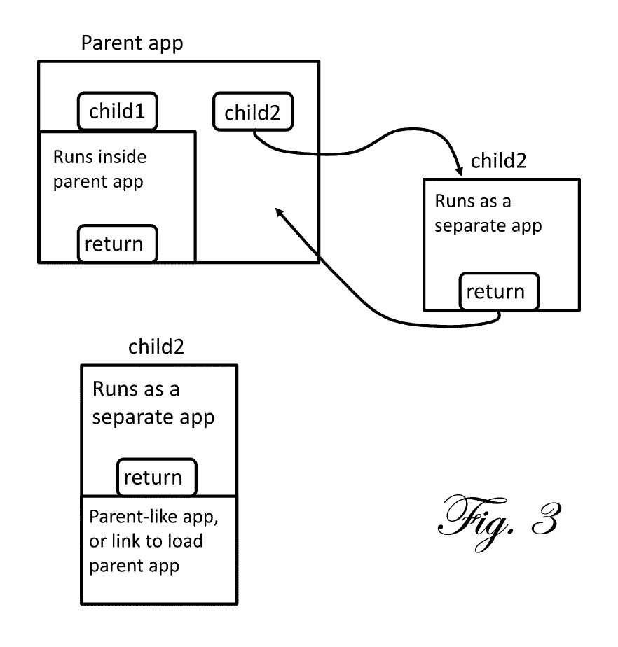

FIG. 3 is a schematic representation of multiple apps operating in a coordinated fashion. The parent app can comprise a library, book or game collection, or bookshelf presentation, allowing a user to select among several child apps, each of which can comprise an app that presents a unique book or game or other app. Child apps can be acquired by download into the parent app, in which case they run within the parent app. This can be accomplished by storing the content of a book in a database in a way that a parent app can interpret the data and implement the presentation of a book or other app. If a book is standalone, then the book itself can interpret its data. A parent app can interpret the locations and parameters of background images, the locations and parameters of foreground images, the location and parameters of text, the location and parameters and functions of interactive and animated objects, the coordination of music and sounds or any other content, and the presentation of any content based on a user's preferences or customizations, as examples. Child apps can also be acquired as stand alone apps, in which case they run separate from the parent app. It can be beneficial to present a unified interface to the user, however, so that the user can access all the acquired books from within the parent app without having to remember which run inside the parent app and which run separately. The parent app can present each type of child app to the user with the same launch indication, for example a button, or an icon representing the book. For child apps that run inside the parent app, the launch indication begins running the child app portion of the parent app. For child apps that run separate from the parent, the launch indication initiates operation of the child app and switches from the parent app to the child app. The interactions with both types of child apps can be made to look the same or similar, so that a user simply accesses the content in a consistent way.

The user also desires to experience a consistent interface for returning to the parent app, e.g., the library or bookshelf. A consistent indication for returning to the parent, e.g., a button or icon representing the parent, can be provided in the parent app for child apps that run inside the parent app, and can be provided in standalone child apps. The return indication in a child app that runs inside the parent app returns to the portion of the parent app that implements the parent functions, e.g., the library or bookshelf. The return indication in a standalone child app launches the parent app, if necessary, and switches from the child app to the parent app. The user thus experiences the same interaction is each case and the distinction between internal child apps and standalone child apps does not complicate the user experience. The consistent interface is maintained when the user acquires the same app but in different form, e.g., if the user has an internal child app, and later acquires the standalone version of that child app, the user interaction with the launch and return functions of the app can be unchanged.

In some situations, the user might acquire a child app without first acquiring the parent app. Child apps can accommodate this situation, and continue to supply the consistent user experience that is desired, by including in the child app at least one of (a) a parent-like app, and (b) a link or prompt to acquire the parent app; as shown in the lower left of FIG. 3. E.g., a child app can look for the parent app when the return indication is received. If the parent app is not present, then the child can implement the required functions of the parent app, which can be a subset of the total parent app since the functionality that is required to manage multiple child apps need not be present in the child app implementation of the parent app. E.g., if the parent app implements a bookshelf metaphor, the child app internal implementation of the parent app can accommodate a single book on the bookshelf or it can accommodate transfer to multiple standalone apps, or it can even mimic the function entirely of the parent app, which control can be transferred when a parent app is acquired. A child app can also simulate other aspects of a parent app before the parent app is acquired, such as a store to view other available apps. The child app can also, or in the alternative, facilitate acquisition of the parent app when the return indication is received. A parent app can have other functionality such as an internal game or other form of entertainment or value to further incentivize people to obtain the parent app. A child app with an internal representation of a parent app can have this functionality to maintain a consistent interface or added functionality can be removed in order to further incentivize users to get the parent app. Child apps that incentivize the download of a parent app, which can be free for example, can lead to many more downloads of a single parent app than any one child app. This can be valuable for Search Engine Optimization.

The parent app can also facilitate consistent user interaction at the top level of the user interface. The parent app will typically have its own icon on the home or other level display of the user interface on a device such as a tablet or smartphone. Each standalone child app will also typically have its own icon. The parent app can place a child app icon on the home or other display screen for each child app that is acquired that is internal to the parent. Starting the child app from that icon will then launch the parent app with that child app already enabled, such that the user experience is similar when launching from an onscreen icon without regard to whether the icon launches a standalone child app or a child app internal to the parent app.

A parent app can access an online database to coordinate its interactions with child apps. For example, as a new child app is released on an app store, such as the Apple App Store, the database can be updated so that the parent app knows that the child app is available and how to check if it has been installed. The database can include information such as store information to present to a user which apps are available, which in-app purchases are available, how much new content costs, and how to get new content. The database can include pointers to files to represent books within a library or a store, or pointers to download books themselves. The database can include information on how books are stored or implemented on a given platform. The database itself can be comprised of multiple databases in various forms, for example, such as a SQL databases. The database can allow a user to log in, and present information specific to the user in the parent app, such as previously purchased books that are available to download which are associated with that account, user preferences that have been entered previously, or social network information such as a list of friends, as examples.

Standalone apps which a parent app can initiate can be made by the same developer, or they can be implemented by inserting a small amount of code into other developers' apps. For example, a parent app can be used as a single point of entry for both a library and a store of many different developers' apps. The parent app can switch to any of the apps that had the code inserted. The code can indicate concepts like how to switch between a parent app and a child app, and how to present that capability to a user. In this way, a consortium of developers can work together utilizing a single parent app. A parent app developed in this way can still work with standalone apps and internally downloaded apps, with consistent data representations along with the 3rd party apps that do not have consistent data representations.

Child apps run internal to a parent app can facilitate lending or transferring or copying of child apps (or, to the user, of the books or games or other apps presented by the child apps). Even if the user acquired the book as a standalone child app, initiating a lending action can cause the parent app to bring the child app into an internal operating environment, such that the parent app can control the access to the child app during the loan period. Users can create accounts with which they can transfer, lend, or in any other way allow a copy of a book or app on another user's device. For example, users can be allowed a specific number of times they can give a book away to friends, when they purchase a book. Similarly, an example embodiment of the present invention would allow users to lend books or other apps to each other. The book can be removed from a user's library when it is lent, or it can remain in the user's library. Users can indicate who will get a lent book through a username, identification number, or email address as examples. This functionality can be implemented either with standalone apps or with internally downloaded apps. For example, a user can purchase a book as an in-app purchase from a parent app, and that app can then be downloaded into the parent app. When a user starts the downloaded book, an indicator can be shown that describes to the user that he or she can lend the book, or that a number of copies may be given to friends. Similarly, a standalone book can have the same indications. When a user is given the right to download a book by another user, the books can be downloaded as standalone apps or can be downloaded within a parent app. In some situations, such as the Apple App Store, apps that are allowed on the store are not allowed to have a lending or transferring feature. In that case, a parent app can be used to implement the permission of one user to another user to download a book or other app. Users can coordinate interactions with each other by knowing their user ID's, for example, or through a social network where they indicate electronically that they know each other. In the case where users develop a network, apps can allow a user interface to easily access and communicate with each other.

In another example embodiment of the present invention where books (or other apps) can be lent from one user to another, the book apps can be purchased and/or downloaded by a library or other user who intends to loan the books to others. Other users can then borrow the book apps by registering with the user who is loaning the books (for example, by getting a library card from an established library). The loaning of books can be implemented through a parent app. A user can download the parent app, which can be free, and indicate in the parent app that the user would like to download a borrowed book from a loaning entity. The parent app can communicate with the loaning entity's online system and verify that the book can be downloaded. When the book is downloaded, it can be removed as a loanable book for the loaning entity until the book is returned. This coordination of an online database accessed by the parent app, and an online database maintained by the loaning entity allows a lending system.

A parent app that downloads app content, such as book content, can interpret the content to allow functionality that is not currently available with eBooks. eBooks, or electronic books, are currently used by users differently than apps, such as on Apple's App store. An eBook, for example, can be purchased and read on Apple's iBooks app. eBooks, however, are primarily text based, and typically have little if any interactivity. A eBook app, like the iBooks app, cannot typically be updated as often as 3rd party apps as well. That is part of the reason that many books, particularly children's books, are implemented as apps rather than eBooks. Apps, however, are more constrained in how they are transferred than eBooks given their broader functionality. A parent app can be used to interpret data representing a book app in a way that gives more functionality than eBooks. The parent app can have built in functionality, such as recording your own narration, which works across many downloaded book apps. The parent app's functionality can continually be upgraded to add functionality to any previously or future downloaded book apps. The parent app can also interpret data specific to the book app itself, to give it increased functionality.

A book app can have its data represented in a database, for example. The database can indicate many aspects of a book or other app, such as Stories, Pages, text, Event Objects, User Interface Objects, Narration, Characters, music, sounds, Variables, or other book elements or Book Properties. As examples of implementations of the present invention, each of these concepts can have a number of variations. Book Properties can define any broad aspects of how a book app works or is presented to a user. Stories can represent groups of pages. Stories can vary from one another by telling completely different plots, or simply by slightly varying text on pages. Stories can be comprised of any number of Pages and different stories can share Pages. Pages can have any number of elements in them. A page can contain a background, text, Event Objects, User Interface Objects, Characters, Music, Sounds, or other book elements. Variables can affect how book elements are presented to a user, and they can change over time. Variables can be used, for example, to represent a user's customizations or how a page is presented or even the flow or plot of a book. Event Objects and User Interface objects can be implemented as touchable or clickable Interactive Objects. An Interactive Object can be an animated character or it can be a button as examples. In addition to being content presented to a user, Interactive Objects can adjust variables or program state or in other ways modify the presentation of Pages. Interactive objects can even be implemented in a way that users do not see them, but they control the presentation of a book behind the scenes. Characters can be defined for a particular Story, or in some book app embodiments, can be chosen by a user and then are utilized within pages based on what the user chooses, along with modifications to text, for example, to match the choice.

The user interactivity can also be customized. Touchable objects can be embedded in a book app; for example touching a character on the screen can cause the character to perform an action such as moving, smiling, or winking. The animation accompanied with such touches can be configured to autorun, such that the user does not need to touch the object. The level of animation can also be configured; e.g., the user can select for multiple objects per page; the user can select for length of animation effects; the user can select for scope of animation effects such as magnitude of motion. The response to a touchable object can be initiated by a simple touch, and can also be initiated by a more complex input such as a gesture, multiple simultaneous touches, a sequence of touches or gestures, and sound input optionally coupled with one of the previous. The input can be used as a teaching tool; e.g., an “apple” can spin if the reader correctly inputs a gesture forming the letter “a”, or if the user correctly pronounces the word “apple.”

An input such as those described above can also be used to control variations in the story presented to the user. As an example, a gesture or other input can be used to change the state of a character (e.g., touch the sword to pick it up), which then affects the presentation of the story (e.g., a later encounter with another character is different if you have a sword than if you have a walking stick). Such story variations can be controlled by (as examples only) selection of objects to carry, pick up, or discard; selection of doors to enter or path forks to take; selection of other characters with whom to interact; selection of foods to eat or drinks to drink; selection of clothes to wear; etc.

Any of the many customizable aspects described herein can be customized by direct user control, and can also be controlled by indirect reference to other sources of information. As examples, information on facebook, amazon, or other online facilities can be used to control names of characters; places where events occur; dates and times such as birthdays, anniversaries, and trips; items purchased for inclusion in the story or in the background of the story. Photos or graphic images can also be mined from such sources and incorporated into stories.

Multiple readers of the same book (equivalently, users of the same child app) can have their interactions with book/app linked. For example, sounds can be linked such that users experience the same sounds, or such that users can initiate sounds that are then played to other users. A grandmother can read aloud a book on her tablet, and her grandchildren, perhaps far away, can see the same pages and hear her voice. Her voice can be recorded for later playback on the child's device, with page turning under the child's control or locked to the progression and pace of the original reading by grandmother. Pages can be turned by the grandmother, or by the children if multiple controllers are desired. Customizations can also be coordinated among multiple readers/users, for example by allowing different users to specify different customizable aspects such as character names, or using information about the users to control customizations such as using their actual location as a setting in the book, or their names or other accessible information in the book. Multiple users can also provide multiple interaction inputs, for example each user can be customized to a different character in the story, and their interaction as their characters can be integrated into a unified presentation of the story to all shared readers. As an example, John can be the prince, and Jane the princess. When John picks up a sword by a gesture or other input, the prince in the story (on the tablet or other devices of both John and Jane) carries the sword.

Aspects of the books can be customized based on user characteristics that are not directly controlled by the user. As an example, browsing or purchasing history can be used to select products to be placed in the story, such as having a character drive the type of car driven by the reader/user, or read the news sources most frequently read by the reader/user. These types of customizations can be used to make the story more familiar to the reader/user, and can also be used to place products in the story in hopes that the user will be prompted to purchase them (similar in effect to product placements in movies and television shows).

The graphic representations of characters can also be customized by a user. For example, the app can present a library of standard character attributes such as clothing style and color, skin tone, height, body parts as arms and legs, and accessories such as hats or capes. The user can assemble a desired custom character that is then presented as part of the book.

The words in a book can be highlighted, or pages turned, based on the real time reading or recorded narration of a book. Software can find silent spaces indicating gaps between words, or voice recognition software can be used to identify words, and the text on the screen highlighted to match the word being said. Playback of a recorded narration can also be adjusted based on text attributes, such as a different voice or voice effect (e.g., volume, pitch, pace) for quotes from a specific character.

A parent app can provide robust search features based on usual attributes such as title and author. The searches can also accommodate searches based on customized features; e.g., search for all books narrated by grandmother. The parent app can also customize the presentation of the library based on user characteristics. E.g., if a user frequently visits sports-based web pages, then stories related to sports can be featured in the parent app. E.g., if a user has indicated likes or dislikes online, or submitted votes in online polls, or entries in online contests, or played online games, or other indicia of user characteristics, then the parent app can feature books responsive to such characteristics.

A parent app can present books to the reader/user, and can also present related content such as games. The games can reflect user preferences as described above, and can make use of book customization information. E.g., a game can feature characters, names, places, etc. taken from those specified for a book customization.

A parent app can also implement supervisor control functions, such as parental controls on which books are presented, e.g., for age-appropriateness, or to target specific interests, or to rotate available books to maintain interest. Such controls can also limit the customizations, e.g., to prevent a child from recording a narration over one already present.

The present invention(s) has been described as set forth herein in relation to various example embodiments and design considerations. It will be understood by someone of ordinary skill in the art that the above description is merely illustrative of the applications of the principles of the present invention(s). Other variants, combinations, equivalents and modifications of the invention(s) will be apparent to those of skill in the art. The invention(s) should therefore not be limited by the above described embodiments, methods, and examples, but by all embodiments and methods within the scope and spirit of the invention(s).

We claim:

1. A system for allowing a user of a mobile computing device to interact with content, comprising a mobile computing device, having accessible thereto program instructions implementing a parent app, a first child implementation, and a second child app, wherein:
the parent app implements a user interface that allows a user of the parent app to select from among a plurality of separate content items, and allows the user to interact with the content from the selected content item, and returns to the selection interface upon completion of the user interaction with the previously selected content item;
the first child implementation comprises content that the parent app accesses to present to the user when the content item corresponding to the first child implementation is selected by the user, and wherein the user can return to the selection interface from interaction with the content;
the second child app comprises content and an app that can operate without the parent app, and allows the user to interact with the content when the second child app is operating, and that provides for initiation of the parent app upon exit from the second child app.2. A system as in claim 1, wherein the mobile device presents an icon that initiates operation of the parent app, and presents an icon that initiates operation of the second child app, and presents an icon that initiates operation of the parent app with the first child implementation active within the parent app.

3. A system as in claim 1, wherein the user interaction with the second child app is substantially similar to the user interaction of the content in the second child app if such content were implemented within the parent app.

4. A system as in claim 1, further comprising a third child implementation, wherein the third child implementation comprises content substantially the same as that in the second child app that is accessible by the parent app, and wherein user interaction with the parent app when accessing the third child implementation content is substantially the same as the user interaction with the second child app.

5. A system as in claim 1, further comprising a third child app, where the parent app allows the user to select the third child app in a manner substantially similar to the selection of the first child implementation and that second child app, and wherein the second child app and third child app have at least a subset of the parent app selection interface replicating the subset of the interface if the user does not have the parent app.

6. A system as in claim 5, wherein the subset of the selection interface includes the selection interface and the selection interface within the second child app can be used to select the third child app and the selection interface within the third child app can be used to select the second child app.

7. A system as in claim 1, wherein the parent app allows selection of new content to add to the parent app, and accesses from storage remote from the device a corresponding child implementation corresponding to a new content selection.

8. A system as in claim 7, wherein the parent app allows selection of new content to be added to the mobile device as a separate app and accessible in the selection interface.

9. A system as in claim 1, wherein the first child implementation comprises a database defining text and images corresponding to a book, and wherein the parent app accesses the database and allows the user to interact with the content in a manner similar to a physical book.

10. A system as in claim 9, wherein the data base further comprises one or more of sound and animation relating to the content, and wherein the parent app accesses the database and provides sound, animation, or both, to the user as the user interacts with the content.

11. A system as in claim 9, wherein the parent app allows specification of one or more customizable elements relative to the content, and wherein the user interaction with the content is customized responsive to such specification.

12. A system as in claim 11, wherein the one or more customizable elements comprise one or more of:
name of a character, image of a character, setting of a story, objects carried or wielded by a character, preferences of a character.

13. A system as in claim 10, wherein the sound comprises audio information presenting a read aloud interaction with the content.

14. A system as in claim 10, wherein the sound comprises audio information presenting background music to be played during interaction with the content.

15. A system as in claim 10, wherein the animation comprises specification of motion of an element of an image presented to the user during interaction with the content.

16. A system as in claim 9, wherein the parent app further accesses information outside the database and modifies the content based on such information.

17. A system as in claim 16, wherein the information comprises information related to the current state of the mobile computing device.

18. A system as in claim 17, wherein the information comprises one or more of: the current location of the mobile computing device, environmental conditions of the mobile computing device, photos stored on the mobile computing device, status of other apps on the mobile computing device, other data on the mobile computing device.

19. A system as in claim 16, wherein the information comprises information stored remote from the mobile computing device.

20. A system as in claim 19, wherein the information comprises one or more of: personal information relevant to the user stored in social media facilities, ordering or purchase history at one or more online stores, browsing history, music preferences relative to the user, information concerning other individuals connected with the user in online information, and travel history relevant to the user.

21. A system as in claim 19, wherein the information comprises information stored in an online account associated with the user, wherein the online account also stores specification of content accessible by the user.
